(19) United States
(12) Patent Application Publication
(10) Pub. No.: US 2007/0096358 A1
(43) Pub. Date: May 3, 2007

(54) Process and extruder nozzle for producing tubular extruded products

(76) Inventors: Antal Pelcz, Budaors (HU); Tamas Illes, Lakhegy (HU); Lajos Szabo, Soskut (HU)

Correspondence Address: YOUNG & THOMPSON, 745 SOUTH 23RD STREET, 2ND FLOOR, ARLINGTON, VA, 22202, US

(21) Appl. No.: 10/560,430

(22) PCT Filed: Feb. 27, 2004
(86) PCT No.: PCT/HU04/00018

§ 371 Date: May 12, 2006

(30) Foreign Application Priority Data
Jun. 20, 2003 (HU) P0301905

(51) Int. Cl. B29C 47/20

(52) U.S. Cl. 264/209.8; 425/461

(57) ABSTRACT

A process and an extruder nozzle for tubular products includes the steps of feeding pressurized material into an extruder nozzle through an inlet, and forcing this material flow through a duct formed between outer and inner nozzle components, and pressing the material flow through an annular aperture at the duct end. Material entering the extruder nozzle is distributed first by feeding into an annular expansion chamber whose cross-section is much greater than the inlet's. When the expansion chamber is completely filled with material whose pressure has become higher than the flow resistance of a homogenizing ring channel having a cross-section narrowed to and connected to the annular expansion chamber then in the homogenizing ring channel the material flow is forced to move across its entering direction, and is homogenized by the relative rotation of surfaces of the homogenizing ring channel. Helical forced movement leads the material to a drawing aperture.

### FIELD OF THE INVENTION

The present invention relates to a process and an extruder nozzle for production of extruded tubular products, particularly blown tubular plastic foils (film hoses). Such plastic foils can be used e.g. for packaging of different products.

### BACKGROUND OF THE INVENTION

There are processes and devices known in practice, used for producing blown foil hoses from thermoplastic materials using an extruder nozzle. Such nozzles are mainly vertically arranged, having a radial inlet for the thermoplastic material connected to an outlet of a generally horizontal extruder screw. In practice, it is a serious problem to ensure a continuous uniform thermoplastic material flow. The tubular product, mainly foil hose exiting from the annular extruder nozzle is stretched to reach a required diameter and wall thickness. In order to provide with an air chamber required for blowing, the foil hose is led through two pinch rolls, which also exert a force required for take-off of the product. The main parameters applied for the traditional processes mentioned above:
Longitudinal stretching of the foil hose: 5 to 10 times;
Transversal stretching of the foil hose: 1.3 to 5 times;
Size of nozzle annular opening: 0.5 to 1.5 mm;
Take-off speed: 1 to 20 m/min;
Foil hose diameter: 230 to 750 mm;
Cooling capacity of the extruder nozzle: 1 to 8 kW.

A basic precondition for producing foil of uniform thickness is an uniform cooling of the blown foil hose exiting from the extruder nozzle; this means that the solidification points of the foil hose must be in the same horizontal plane, otherwise some parts of the product will extend and swell differently, therefore crawling may occur, which may lead to serious problems when rolling of the product.

In the above extruder nozzle, the material flow arriving from the extruder screw progresses from the horizontal inlet into a central vertical duct, then the material flow is distributed into a plurality of small diameter holes, each of which leads to a respective spiral channels provided between an inner component (core) and an outer component of the nozzle. These spiral channels are one pitch long, and both the guide curve of the channels and the external skirt surface of the nozzle core are conical. As a result of these two conical properties, the spiral channels run out of the skirt surface by the end of the pitch and a transfer cross-section is transformed into a common narrow annular cross-section. By adjusting the relative axial position of the inner and outer components of the nozzle, the outlet cross-section—that is, the diameter and the opening size of the finishing “drawing” aperture—can be adjusted.

Further application problems of the known foil blower extruder nozzles primarily come from the fact that extruder screws are generally installed in a horizontal arrangement, while foil blowing and thus the extruder nozzle has a vertical axis. Although a substantially homogeneous material flow is generated at the extruder screw outlet, transition from the horizontal to the vertical direction frequently produces inhomogeneous parts in the plastic material flow, inevitably leading to finished product quality deterioration.

A further problem of the known extruder nozzles is that the structural units of the external and the inner components of the nozzle are fastened to each other, therefore their relative position (concentricity, coaxiality) is determined by the fit, as well as the shape and position tolerance of the respective component parts. Accuracy, however, is limited by the present manufacturing technology, and inaccuracies generally result in non-constant drawing opening size.

Furthermore, heater units arranged at the external nozzle component heats the plastic material in the known extruder nozzles. According to our practical experience, however, plastic material is not subject to even thermal loads along the perimeter of the extruder nozzle. Not more than 50% of the heat—usually generated electrically—gets to the plastic material by heat transfer, therefore the material actually heats up the nozzle core, therefore the external wall of the outer nozzle component is certainly warmer than the plastic material, so sticking—perhaps burn-down—is more probable. As known, plastics are prone to sticking as a matter of course.

As in the known arrangements the outer and inner nozzle components are usually rotated together, the stuck plastic material can only be torn by an axial material flow. However, this entails that further particles stick to the already stuck particles, therefore they swell and “leave a trail” in the material flow. Having reached a critical size, they are separated from the material surface and, integrated into the material flow; they generate a “tear junction” in the product. And this may result in as much as ±20% differences in foil hose thickness. As this phenomenon can be traced back to reasons of construction, this defect rate may not or may only slightly be reduced. Thickness differences in the foil hose will result in conical rolls at the time of rolling up. In the event of major defects, rolling up is made practically impossible.

However, the co-rotation of the outer and inner nozzle components brings up further problems as well. As the bearing system operates at high temperatures (approx. 200-250° C.), the lubricant melts out and requires continuous replacement. Furthermore, power supply for heaters and the electrical connection required for machine control must be provided through slip rings and control units for the heaters must be installed on the outer rotating part. Thus, the structural design, operation, and maintenance of the extruder nozzle become too complicated.

U.S. Pat. No. 4,541,793 discloses another extruder nozzle for producing plastic products, wherein in order to homogenize material, a set of bearing balls are placed between the internal and external nozzle parts rotated in directions contrary to each other, for such balls to act as mixing elements. The external part of the nozzle is embedded into a bearing system consisting of bearing balls as opposed to the internal part thereof, arranged one after the other in axial direction in an annular grooves delimited by the internal and external parts, respectively, and the plastic material flow is pressed through the gaps between the bearing balls to the direction of the drawing aperture at the outlet end of the annular channel.

The problems described above in relation with the rotation of the outer and inner nozzle parts appear here as well, on the one hand, and rotation into different directions requires a much more complex rotating drive system, which further increases costs and structural complexity. Furthermore, a “trailing” phenomenon arises in the material pressed through the gaps between the bearing balls as in the case of the spiral channels mentioned above, which is to the detriment of product quality.

According to our practice the extruder nozzle plays a complex role: to change the direction of material flow, to distribute the material to an annular cross-section, to eliminate inhomogeneity caused by the change of direction, and to ensure a constant drawing aperture size of the outlet cross-section. Perfect product could be produced only, if the material was completely homogeneous and the size of the drawing aperture was constant; this, however, cannot be guaranteed by the known solutions of the prior art.

### SUMMARY OF THE INVENTION

The primary object of the present invention is to eliminate the deficiencies mentioned above, that is, to create an improved solution by which extruded products, e.g. plastic foils—particularly blown foil hoses—can be produced more economically and in considerably more even and better product quality than by known technologies.

A further object of the invention is to provide completely homogeneous material flow in the nozzle, that is, evenly distributed and of identical temperature within the structurally simplified extruder nozzle, and to have the size of the outlet cross-section, that is, the drawing aperture constant throughout the operation.

A process according to the invention can be used for extruding tubular products, particularly blown plastic foil hoses. It comprises the steps of feeding a pressurized material, particularly thermoplastic material flow into an extruder nozzle, and forcing the material flow through a duct formed between an outer and an inner extruder nozzle components, then shaping the tubular product by pressing through an annular drawing aperture at the duct end of the extruder nozzle. The essence of this process lies in that the material flow entering the extruder nozzle through an inlet is distributed first—in the direction of progress of the entering material flow—by being led into an annular expansion chamber, the cross-section of which is selected much greater, advantageously of at least one order of magnitude greater than that of the inlet. When the annular expansion chamber has been completely filled up by the material flow whose pressure has become higher than the flow resistance of a homogenizing ring channel having a transfer cross-section narrowed to and connected to the annular expansion chamber, then, in the homogenizing ring channel the material flow is forced to move in cross direction to the entering direction thereof, and it is homogenized by the relative (mutual) rotation of surfaces at least partly delimiting the homogenizing ring channel, and the material flow is led to a drawing aperture by way of a spiral (helical) forced movement.

According to a further feature of the process, the nozzle core can be embedded in the external nozzle part and centralized, at least partly, by the material flow kept in forced motion.

The material flow in the extruder nozzle is kept at the required temperature by the internal heat generated in the material flow itself as a result of kneading work performed by the forced motion of the material flow.

The above process can be carried out by an extruder nozzle for producing tubular products according to the invention, comprising an external nozzle component and an internal nozzle core embedded therein, and a material distribution duct arranged between the external nozzle component and the internal nozzle core. The external nozzle component has an inlet for receiving the pressurized material, which is connected to a drawing aperture through the duct. The external nozzle component and the internal nozzle core of the extruder nozzle are arranged relatively (mutually) rotatable, for which the external nozzle component and/or the internal nozzle core is provided with a rotary drive, preferably with controllable rotary speed. Said material distribution duct comprises an annular expansion chamber connected to the inlet, the cross-section of the annular expansion chamber is much greater, advantageously of at least one order of magnitude greater than that of the inlet. Said material distribution duct comprises a homogenizing ring channel connected with its one end to an outlet of the annular expansion chamber and its cross-section is narrowed to the required proportion—compared to the annular expansion chamber—, and its other end is connected to the drawing aperture.

According to the invention such an embodiment of the extruder nozzle is also possible, which comprises an external nozzle component and an internal nozzle core embedded therein, and a material distribution duct formed or arranged between them. The external nozzle component having at least an inlet for receiving at least one pressurized material, which is connected to a drawing aperture through at least one duct. It is characterized in that the extruder nozzle is suitable for producing multi-layer tubular products, wherein the material distribution duct comprises a first annular expansion chamber connected to a first inlet receiving a first material flow, the cross-section of said expansion chamber is much greater, advantageously of at least one order of magnitude greater than that of the first inlet. Furthermore, the material distribution duct also comprises a first homogenizing ring channel connected preferably co-axially to the expansion chamber. The cross-section of the first homogenizing ring channel is narrowed to the required proportion compared to said first expansion chamber, and is partly delimited by an inner skirt surface of a delimiting sleeve embedded freely rotatable in the external nozzle component. An outer skirt surface of the delimiting sleeve delimits a second homogenizing ring channel of a cross-section narrowed to the required proportion, one of the ends of which is connected to a second inlet for receiving a second material through a second annular expansion chamber which is much greater, advantageously of at least one order of magnitude greater than the cross-section of the second homogenizing ring channel or the second inlet. The other ends of the first and second homogenizing ring channels are connected to a common ring chamber joining the homogenizing ring channels, and it is connected to the drawing aperture. The outer and inner nozzle components and the at least one delimiting sleeve are arranged relatively (mutually) rotatable, and the external nozzle part and/or the internal nozzle core and/or the delimiting sleeve is connectable to a rotarydrive.

According to a further feature of the invention at least one gap-controlling groove is provided which is formed as to control in a predetermined manner the size and shape of cross-section of the gap, and thereby the material flow in the homogenizing ring channel.

Further features and improvements of the invention are disclosed in the description below and in the claims.

### BRIEF DESCRIPTION OF THE DRAWINGS

The invention is illustrated in more detail on the basis of the enclosed drawings, where by way of example three embodiments of the solution according to the invention are shown, in which:

FIG. 1 shows a vertical cross-section of the first embodiment of the extruder nozzle according to the invention,

FIG. 2 shows a vertical cross-section of the second embodiment of the extruder nozzle according to the invention, intended for producing a double-layer plastic hose;

FIG. 3 illustrates a vertical cross-section of an improved version of the extruder nozzle according to FIG. 3;

FIG. 4 is a cross-section along line IV-IV in FIG. 3.

### DETAILED DESCRIPTION OF PREFERRED EMBODIMENTS

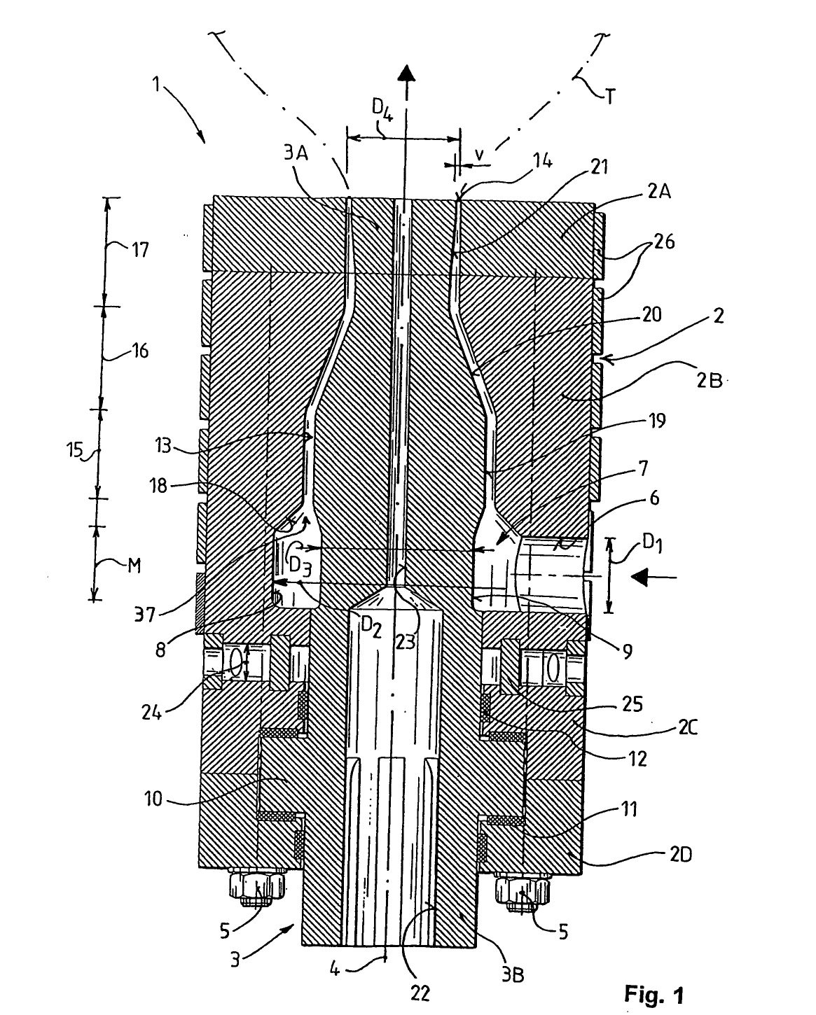

As shown in. FIG. 1, an extruder nozzle 1 in accordance with the present invention can be used for the extrusion of a single-layer foil hose, which foil hose can be used as packaging foil. The extruder nozzle 1 consists of two main parts, namely an external nozzle component 2 and an internal nozzle core 3 relatively rotatable embedded therein. In the present case, the external nozzle component 2 is arranged in a fixed manner, and is formed as a substantially rotation-symmetric element, that is, designed as a cylindrical casing having a vertical longitudinal axis 4.

The external nozzle component 2 is axially divided in the present case, consisting of an upper part 2A, central parts 2B and 2C, and a lower part 2D, arranged coaxially to the longitudinal axis 4 and fixed to each other by 5 screws in a dismountable manner and positioned centrally. The central part 2B of the external nozzle component 2 is provided with a radial inlet 6, through which melted thermoplastic plastics, such as polyethylene, is fed under pressure into the extruder nozzle 1 after exiting from a known extruder screw (not illustrated). A diameter D₁ of the radial inlet 6 has been selected to be 35 mm in the present case.

In accordance with the present invention, the inlet 6 of the extruder nozzle 1 is in connection with an annular expansion chamber 7, whose cross-section is selected substantially greater—favourably at least one order of magnitude greater—than the cross-section of the inlet 6. In the present case, the annular expansion chamber 7 is formed concentric to the longitudinal axle 4, an external diameter D₂ thereof has been selected to be 360 mm in the present case, and a height M of an external cylindrical skirt surface 8 to be 50 mm, respectively.

FIG. 1 clearly shows that the annular expansion chamber 7 is delimited from the inside by a cylindrical skirt surface 9 of the nozzle core 3 embedded rotatable within the external nozzle component 2. A diameter D₃ of the nozzle core 3 has been selected to be 300 mm in the present case. FIG. 1 further shows that the nozzle core 3 is provided with a cylindrical shoulder 10 at its lower part, and in the present case it is rotatable embedded in axial bearings 11 and radial bearings 12 over and under the cylindrical shoulder 10, respectively. In the present case, TEFLON bushings are applied for the bearings 11 and 12; they, however, embed the lower part of the rotating nozzle core 3 enabling a slight radial displacement for its upper part, that is, some “self-positioning”.

According to FIG. 1, over the annular expansion chamber 7 the standing external nozzle component 2 and the rotating nozzle core 3 constitute a circular homogenizing ring channel 13 of relatively narrowed cross-section—compared to the expansion chamber 7—, whose outlet at the upper part of the extruder nozzle 1 constitutes an annular product-forming (“drawing”) opening 14. In the present case, the homogenizing ring channel 13 comprises a substantially cylindrical lower section 15 an upwards conically narrowing intermediate section 16 and an upper section 17. The lower section 15 is connected to the annular expansion chamber 7 by a conical surface 18. An external skirt surface of the rotating nozzle core 3 delimiting the homogenizing ring channel 13 from the inside is composed of a lower cylindrical surface 19, a conically upwards narrowing surface 20, and an upper conically somewhat broadening surface 21.

FIG. 1 shows that the internal nozzle core 3 is also formed as a rotation-symmetric unit, so its skirt surfaces can be produced by simple machining. At its lower end, the nozzle core 3 is provided with an axial grooved hole 22, that can be connected to a ribbed shaft of a known rotary drive (not illustrated) and thereby the nozzle core 3 can be rotated. Furthermore, the nozzle core 3 is provided with a central longitudinal duct 23 to feed in pressurized air into the foil hose produced. Therefore the foil hose can be blown, stretched, and possibly cooled in a known manner. The foil hose exiting through the drawing opening 14 of the extruder nozzle 1 and blown by pressurized air through the duct 23 is indicated by a thin dash-and-dot line and a reference character “T” (FIG. 1).

In FIG. 1, a distance 24 is left between the central parts 2B and 2C of the external nozzle component 2, being connected to each other only through relatively narrow rings 25 for reducing heat transfer. Therefore it has been achieved that while the upper part 2A and the central part 2B of the external nozzle component 2 work at an operating temperature of about 250° C., the operating temperature of the parts 2C and 2D does not exceed 150° C. This way the thermal load of the parts 2C and 2D embedding the bearings 11 and 12 can be reduced effectively.

The rotary drive (not shown) connected to the hole 22 of the nozzle core 3 may contain a hydro-motor (e.g. with ribbed shaft), whose number of revolutions has been selected to be 20/min, for instance, in the course of our experiments.

As to the extruder nozzle 1 in FIG. 1, an external diameter D₄ of the drawing opening 14 has been selected to be 303 mm and a gap v of the drawing opening 14 to be 1.5 mm. Thickness of the foil tube T exiting from the vertical extruder nozzle 1 was set at 10 micrometers during experiments, and the cylindrical parts of this foil tube T was blown to a diameter of about 1000 mm.

As to a provisional heating of the extruder nozzle 1 in accordance with FIG. 1, there is a heating device 26 arranged along the outer skirt of the parts 2A and 2B of said fixed external nozzle component 2, which may be electrical heating known in itself. With a view to the fact that the external nozzle component 2 is standing, it is extremely simple to arrange, provide power supply for, and control the heating device 26. In the preferred embodiment of the invention, the heating device 26 is intended to heat up the extruder nozzle 1 before starting operation and keep it at an operating temperature (it will discussed below).

The extruder nozzle 1 in FIG. 1 operates in the following manner:

First the heating device 26 is switched on and the extruder nozzle 1 is heated up, e.g. to the operating temperature of 250° C. Then melted and homogenized polyethylene material flow is continuously fed in through the radial inlet 6 to the extruder nozzle 1 by the extruder screw (not illustrated) at a pressure of 30 MPa and at a temperature of approx. 250° C., for instance. (No mention will be made of other preparatory operations of foil production known in themselves, such as pulling the hose and inserting it between the drawing roll pair.)

Through the inlet 6, the material flow suddenly gets into the annular expansion chamber 7 of substantially larger cross-section, which latter makes it possible, due to its size, that the fluid plastic material run around and fill in first the annular expansion chamber 7 while the nozzle core 3 rotates—e.g. with a revolution number of about 20/min—, and thereby enforces the expanded plastic material to move clockwise in the expansion chamber 7.

FIG. 1 clearly shows that the relatively narrow (compared to the expansion chamber 7) homogenizing ring channel 13 is connected in a tightened manner due to a conical surface 18 at the upper part of expansion chamber 7, whose flow resistance is considerably higher by definition than that of the annular expansion chamber 7. As a result of the rotation of the nozzle core 3, a significant relative speed difference arises between the inner surface 8 of the standing outer nozzle component 2 delimiting the annular expansion chamber 7, and the sections 15, 16, and 17 thereof delimiting the relatively narrower homogenizing ring channel 13, as well as the surfaces 9, 19, 20, and 21 of the external skirt of the rotating nozzle core 3, which forces the fluid plastic material to move and keep moving as a result of frictional resistance in the annular expansion chamber 7 and—as it rises in a spiral line—and in the homogenizing ring channel 13 as well. This speed difference may even be e.g. 37 m/min (according to our experimental results).

Therefore, by rotating the nozzle core 3 relatively to the outer nozzle component 2, a high speed difference is generated, as a result of which the plastic material between the standing nozzle component 2 and the rotating nozzle core 3 is constantly on the move, so the rotation of the nozzle core 3 performs a continuous kneading and shearing work on the plastic material in the annular expansion chamber 7 and the homogenizing ring channel 13. In the course of this kneading work, heat is generated in the fluid material, which is utilized by virtue of the invention to keep up the required temperature of the plastic material in the extruder nozzle 1. Consequently, the electrical heater device 26 can be switched off after the initial heat-up operation period, thus operating costs can be decreased considerably.

Thus, due to the above relative (mutual) rotary speed difference between the structural parts as well as by the kneading and shearing work of the material, heat has been generated in the material itself, making temperature distribution considerably more balanced than in the case of indirect heat transfer used in the prior art.

FIG. 1 illustrates for skilled persons clearly and concisely that the material flow, entering through the inlet 6 horizontally and radially, is forced to change direction in the arrangement according to FIG. 1 as the foil hose T is blown vertically upwards. However, this potential inhomogeneity arising from such change of direction is completely eliminated by the special design of both the homogenizing ring channel 13 and the expansion chamber 7 as detailed above, thereby performing very effective and perfect homogenization of the plastic material according to the invention.

In the solution according to the invention, the narrowed cross-section of the homogenizing ring channel 13, which is further narrowed in the upper area, represents a considerably greater flow resistance to the material than the annular expansion chamber 7, therefore the material flow only starts upwards in the homogenizing ring channel 13 as a result of the arising pressure difference only after completely filling the annular expansion chamber 7. Nevertheless, the plastic material flow has been somewhat homogenized in the annular expansion chamber 7 as well. In a given case the flow resistance of the homogenizing ring channel 13 can be adjusted accurately, e.g. by selecting the revolution number of the internal nozzle core 3.

The blowing and cooling steps of the foil hose T are not detailed here; these steps may be performed traditionally (and these do not belong to the essence of the invention).

As the material flowing from the annular expansion chamber 7 of the extruder nozzle 1 is forced to move constantly and continuously along a “spiral line” in the homogenizing ring channel 13 towards the drawing aperture 14, the probability of sticking to the nozzle surfaces is minimized. However, any sticking material portions are immediately torn off by the material flow moving both axially and tangentially within the extruder nozzle 1 according to the invention. Our experimental results show that such enforced movement of the plastic material produces such surprisingly even and particularly meshed texture in the plastic that provides the finished products with highly favourable properties.

As referred to above, the fluid plastic material itself—forced to move by relative speed difference and high pressure in the annular expansion chamber 7 and the homogenizing ring channel 13 concentric thereto—constitutes a “sliding bearing” and “lubricant” at the same time, embedding the upper part of the nozzle core 3. This is coupled with a surprising additional technical effect that the upper part of the rotating nozzle core 3 is always accurately adjusted to its central position during operation, therefore according to our tests the gap v of the drawing aperture 14 remains absolutely constant and coaxial with the longitudinal axis 4 of the nozzle 1 throughout operation, which is of paramount importance in terms of the product quality of the foil hose T. Our experiments show that the thickness errors of the product produced by the invention can be reduced by several orders of magnitude compared to traditional solutions. Accordingly, the “play” of the bearings 11 and 12 should be selected so that they enable a slight radial displacement of the “self-positioning” upper part of the rotating nozzle core 3.

In the illustrated embodiment rounded corners were applied at the conically narrowing surface 18 of the annular expansion chamber 7 to prevent “idle” portions in the plastic material flow (FIG. 1).

FIG. 1 shows that the rotating nozzle core 3 is also axially divided in the present case, that is, it consists of an upper part 3A and a lower part 3B, which are coaxially fixed to each other so that they can be rotated together. This is important for the user of the extruder nozzle 1 because various gaps v of the drawing opening 14 can be properly and simply adjusted for production of different foil products having different thicknesses by simply replacing the part 3A, with a correspondingly calibrated opening for the drawing opening 14.

The foil hose T produced according to our invented process and using the above extruder nozzle 1 is uniformly structured and of even wall thickness, therefore it can be rolled smoothly after being led through a drawing roll pair (known in itself and not shown in the drawing) and can be further processed (in a known manner).

One of the important distinguishing features of the extruder nozzle 1 in accordance with the invention is that a relative (mutual) speed difference is generated between at least the surfaces delimiting the expansion chamber 7 and the homogenizing ring channel 13 in order to specifically treat the material, as disclosed above. This relative movement can be produced when the external nozzle component 2 is standing and the internal nozzle core 3 is rotated, or even when these are rotated with different speeds simultaneously in the same direction or different directions; however, we suppose that a person having ordinary skill in the art do not require any further instructions to realize these embodiments on the basis of our above disclosure.

In the packaging technology, there is a frequent need for multi-layer packaging foils, one layer of which—e.g. for hygiene reasons—may get into contact with the products to be packaged, such as foodstuff; this layer can be made of polyethylene (air-permeable), while the other one can be made of polyamide, which may not get into contact with foodstuff, but provides compact sealing in turn.

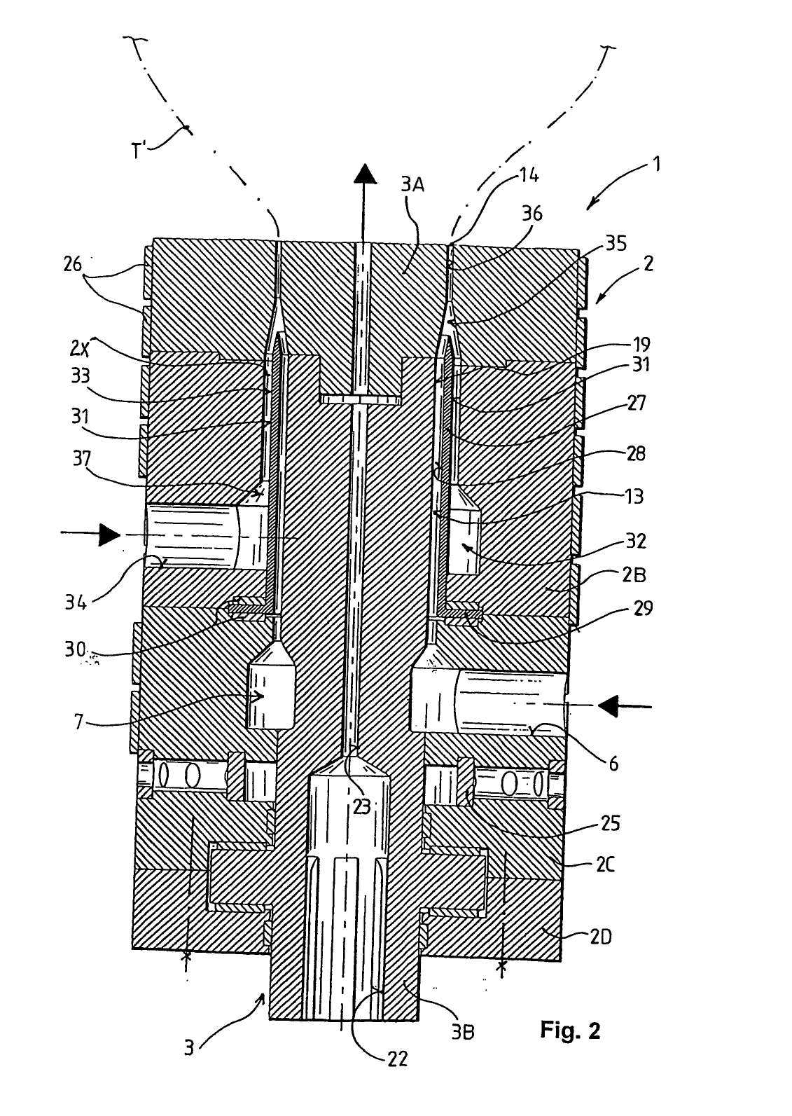

The second embodiment, shown in FIG. 2, of the extruder nozzle in accordance with the present invention is suitable for producing such two-layered foil hose. Similar parts in FIG. 2 have been designated with identical reference characters (as in FIG. 1) for simplicity and better comparability.

The extruder nozzle 1 as shown in FIG. 2 substantially corresponds to the solution according to FIG. 1 both in terms of structure and principle of operation. Said extruder nozzle 1 also comprises two main component parts: a standing outer nozzle component 2 and an inner nozzle core 3 rotatable embedded within said outer component 2. The external nozzle component 2 is axially divided, consisting of parts 2A, 2B, 2C, and 2D, respectively. The rotating nozzle core 3 is to be connected to a rotary drive in a known manner (not shown).

The standing external nozzle component 2 is also provided with a radial first inlet 6 to feed in a first melted plastic material flow under pressure from a first extruder screw (not illustrated), and which leads into a first annular expansion chamber 7 having a substantially larger cross-section. The first annular expansion chamber 7 is also connected to a first homogenizing ring channel 13 of significantly reduced flow cross-section, which latter is in connection with an upper annular drawing opening 14 as outlet of the extruder nozzle 1, where a two-layered foil hose T′ exits and then is blown up by pressurized air in a known manner.

The rotating nozzle core 3 is also provided with a 22 hole suitable to accept a ribbed axle head of a rotary drive (not illustrated) and a central air inlet duct 23 for blowing up the foil hose T′ by pressurized air. A distance 24 and connecting rings 25 are also applied here to reduce heat transfer between the intermediate parts 2B and 2C of the standing nozzle component 2. There is an electric heater device 26 arranged along the outer skirt of the parts 2A and 2B of the fixed external nozzle component 2. For rotating the nozzle core 3 preferably a hydro-motor, or electromotor or other traditional rotary drives (mainly with high torque, low RPM and balanced operation) can be applied.

A difference compared to the embodiment according to FIG. 1 is that in the arrangement according to FIG. 2, the first circular homogenizing ring channel 13 is mostly delimited from the outside by an internal surface 28 of an annular delimiting sleeve 27. Said sleeve 27 is arranged as a thin-wall tube provided with a rim 29 at its bottom, with broken edge at its top, and embedded, in the present case, in bearings 30—freely rotatable and coaxially—in the external nozzle component 2. However, an external skirt surface 31 of the sleeve 27 delimits, from the inside, a second annular expansion chamber 32 with a considerably large cross-section, and a second homogenizing ring channel 33 of reduced cross-section—compared to said expansion chamber 32—connected at the top thereto.

The standing nozzle component 2 is provided with a second inlet 34 leading radially into the second annular expansion chamber 32 at a part of opposite the first inlet 6 in the present case. Through said second inlet 34 a second melted (approx. 250° C.) plastic material flow is fed in under pressure from another extruder screw (not illustrated). It is to be noted that the cross-section proportions of the second inlet 34, the second annular expansion chamber 32, and the second homogenizing ring channel 33 substantially correspond to those mentioned at the first embodiment.

At the time of putting into operation, the extruder nozzle 1 is heated up to an operating temperature of about 250° C. by the electric heater device 26. Then the first plastic melt is fed in at high pressure through the first inlet 6, simultaneously with feeding the second plastic melt through the second inlet 34, and during these steps the nozzle core 3 is rotated at 20 revolutions per minute by the rotary drive. The first plastic material is fed in through the first inlet 6 under a pressure of 30 MPa, which can be polyethylene, for instance, and which the internal layer of the foil hose T′ is made from; and at the same time the second melted plastic material is fed in through the second inlet 34 under a pressure of 30 MPa that can be polyamide, for instance, which the external layer of the foil hose T′ is made from.

The first melted material flow, entering at high pressure, first fills in the first annular expansion chamber 7, and the second material flow fills in the second annular expansion chamber 32, also due to the enforced rotary impact of the rotating nozzle core 3. In the meantime, shearing and kneading works—as already detailed above—are performed in both plastic materials in the nozzle 1, which provides with internal heat generation.

Therefore the external heater device 26 can be stopped after a certain amount of operating time has passed.

As a consequence of the pressure difference generated in the nozzle 1, the high-pressure first material flow, kept rotating by the nozzle core 3, starts upward in the form of a “spiral” from the first annular expansion chamber 7 in the first homogenizing ring channel 13, in the meantime making the delimiting sleeve 27 rotate by way of a friction connection. Similar phenomena takes place in the second annular expansion chamber 32 and the second homogenizing ring chamber 33 as well, however, they are mostly delimited by the external skirt surface 31 of the rotating sleeve 27 (forced to be rotated by the first material flow) as well as by an internal surface 2X of the external nozzle component 2. This is how a relative rotary speed difference is generated between the delimiting elements of the homogenizing ring channels 13 and 33, respectively, as well as in the annular expansion chambers 7 and 32, respectively, according to the present invention.

In operation, the rotating delimiting sleeve 27, kept in enforced rotation by the first material flow, always remains in its centralized position as the pressure of the first material flow—performing a spiral enforced motion upward from the first expansion chamber 7 into the first homogenizing ring channel 13—is substantially identical with that of the second material flow, performing a spiral (helical) enforced motion upward from the second annular expansion chamber 32 into the second homogenizing ring channel 33 caused by the rotated delimiting sleeve 27. At the same time, these material flows centralize the upper part of the nozzle core 3 as well, ensuring a constant aperture gap v at the drawing aperture 14, as referred to above, which is extremely important factor to the higher product quality.

FIG. 2 clearly shows that in the area over the top of the delimiting sleeve 27, the outlets of both homogenizing ring channels 13 and 33 are unified in a common annular joining chamber 35, conically narrowing upwards in the present case, where the first and second plastic material flows—constituting the internal and external layers of the final foil product T′—are joined together. In the present case, the joining chamber 35 is connected to the calibrated drawing aperture 14 through an annular ring-section 36.

According to FIGS. 1 and 2, there is a conical, upward narrowing transfer neck 37—with edges rounded off—inserted between each of the annular expansion chambers 7 and 32, respectively, and the homogenizing ring channel 13 and 33, respectively, which latter have a narrowed transfer cross-section compared to the former, whereby flow conditions were intended to be made more favourable. (The conical surface 18 also forms a part of the transfer neck 37).

The number of revolutions of the rotated delimiting sleeve 27 is, of course, somewhat below that of the direct driven internal nozzle core 3. Relative speed differences are generated between the delimiting surfaces in the annular expansion chambers 7 and 32, respectively, and the homogenizing ring channels 13 and 33, respectively, resulting a surprisingly favourable homogenization effects in the material, according to the invention, as described in detail at the first embodiment.

According to the invention, the inhomogeneity of the material flow caused by a change of flow direction in the extruder nozzle 1 is fully eliminated in a particular way by controlling the flow resistance in the extruder nozzle 1. For the sake of comparison, let us mention that in the case of traditional extruder nozzles, the material could start upwards, immediately after the change of direction, as it was not forced to form a relatively homogeneous horizontal ring and then to flow upwards to the drawing aperture. On the contrary, according to the present invention, the material can only exit upwards from the annular expansion chambers 7 and 32, respectively, to the homogenizing ring channels 13 and 33, respectively, as a consequence of the proposed relative rotation, if the material flow is already so homogeneous that its pressure everywhere is at least as much that it can overcome the flow resistance of the suddenly narrowing homogenizing ring channel. In a case to the contrary, the material attempts to stay in the annular expansion chamber yet. This flow resistance can be controlled, for example by the rotation speed of nozzle core 3, as mentioned above.

As in the case of the above embodiments, the external nozzle component 2 is standing but the internal nozzle core 3 is rotating, a fairly great relative difference of speed is to arise between the material flow delimiting surfaces. Consequently, the material flow is in continuous axial and radial motion, thus the probability of sticking is minimized. Potentially sticking particles are immediately torn off by the material flow moving not only axially, but radially as well. As a result of high-speed rotation and the pressure conditions mentioned above, the mesh texture generated in the material flowing upwards in a spiral form endows the finished product with favourable properties.

Another speciality of the extruder nozzle 1 in accordance with the invention is that, in an original manner, the homogenizing ring channels 13 and 33, respectively, also serve as annual ducts for material flows besides a special centralizing “embedding” of the upper part of the rotating nozzle core 3 by way of the processed plastic material itself. The internal nozzle core 3, embedded rotatable in the external nozzle component 2, is also “lubricated” by the melted plastic material acting as a “sliding bearing” as well, eliminating problems arising in traditional nozzle bearings. By such “embedding”, a substantially “ideal lubrication status” can develop because the high-pressure “lubricant” material fills in the chamber completely, and the constant material flow always provides fresh “lubricant”. Therefore the upper part of the nozzle core 3 does not require any traditional lubrication, which further simplifies the structure and reduces operating costs.

In particular cases, the solution in accordance with FIG. 2 can be adapted for producing foil hoses of three or even more layers. Packaging foil of more than two layers may be justified e.g. by the required good printing properties of the outermost third layer of the product.

Other embodiments are also feasible in accordance with the present invention, particularly in terms of extruder nozzles 1 producing multi-layer products. There is a potential arrangement (not illustrated), for example, where the rotating nozzle core 3 rotates the first delimiting sleeve by shearing the material, this latter also rotates the next one or more delimiting sleeves through the plastic material, which sleeve(s) are also embedded rotatable. By nature of the drive, the speed of the delimiting sleeves will be gradually reduced outwards in the radial direction. This arrangement can be advantageous in the case of layers consisting of materials with close melting point and viscosity values. This construction can also be realized in a version, where the external nozzle component 2 is rotated and this latter rotates the delimiting sleeves by shearing the material.

In yet another embodiment (not shown), the rotating nozzle core 3 may rotates the first delimiting sleeve through a forced coupling, such as a cogwheel, and then this delimiting sleeve rotates the second one through another forced coupling, such as a cogwheel (and so on, up to the last delimiting sleeve). In this case the aim is contrary rotation rather than the difference of speeds, since this way we will not have any nozzle 1 consisting of delimiting sleeves of continuously reducing speed but e.g. delimiting sleeves rotated with identical speed, but in the opposite directions. This nozzle is to be used in the case of materials of highly different viscosity.

However, a relative (mutual) speed difference can also be generated in accordance with the invention in a way that the nozzle core 3 is embedded in a “self-positioning” arrangement (not illustrated); however, it is not rotated, but the delimiting sleeve 27 is rotated instead. In this case, the “sliding bearings” generated from the plastic material are also developed, by which the nozzle core 3 can be centralized satisfactorily. This solution is primarily offered in the case of applying materials of highly different viscosity and melting point values.

The temperature of the extruder nozzle 1 is adjusted at start-up by the heating devices 26 mounted on the external surface of the outer nozzle component 2; then, after the rotation drive is switched on, the role of the heater device 26 will gradually decrease and eventually terminate as the heat required to keep the plastic material flow at the desired temperature is generated within the material itself by the kneading work performed by the rotating nozzle core 3. Therefore heat is actually generated directly within the material itself by rotational energy input, thus even plastic material temperature can be ensured.

In the solution according to the invention, a surprising “self-centralizing” impact is achieved by the recommended arrangement and embedding of the nozzle core 3, by which the current concentricity of the exit cross-section, a constant aperture gap v, and even internal heating of the material can be guaranteed; besides, the hazard of sticking can be completely eliminated. Our experiments show that the quality defect rates of the products thus produced are an order of magnitude less than in the case of known solutions, even they can be kept below ±1%, surprisingly.

Another advantage is presented by the fact that the extruder nozzle 1 in accordance with the invention has been considerably simplified in terms of the number and complexity of components as well. The components consist almost only of rotation-symmetric surfaces; it means that the spiral grooves applied at traditional solutions (requiring costly and special finishing machinery) can be eliminated. Besides the drive, the nozzle consists of nine components only (whereas the traditional nozzle described above consists of at least 15 components).

It is to be noted that in the case of complex foils having 4 to 8, even 10 layers, one or a combination of the embodiments described above should be applied in the function of current operational parameters and the basic materials selected.

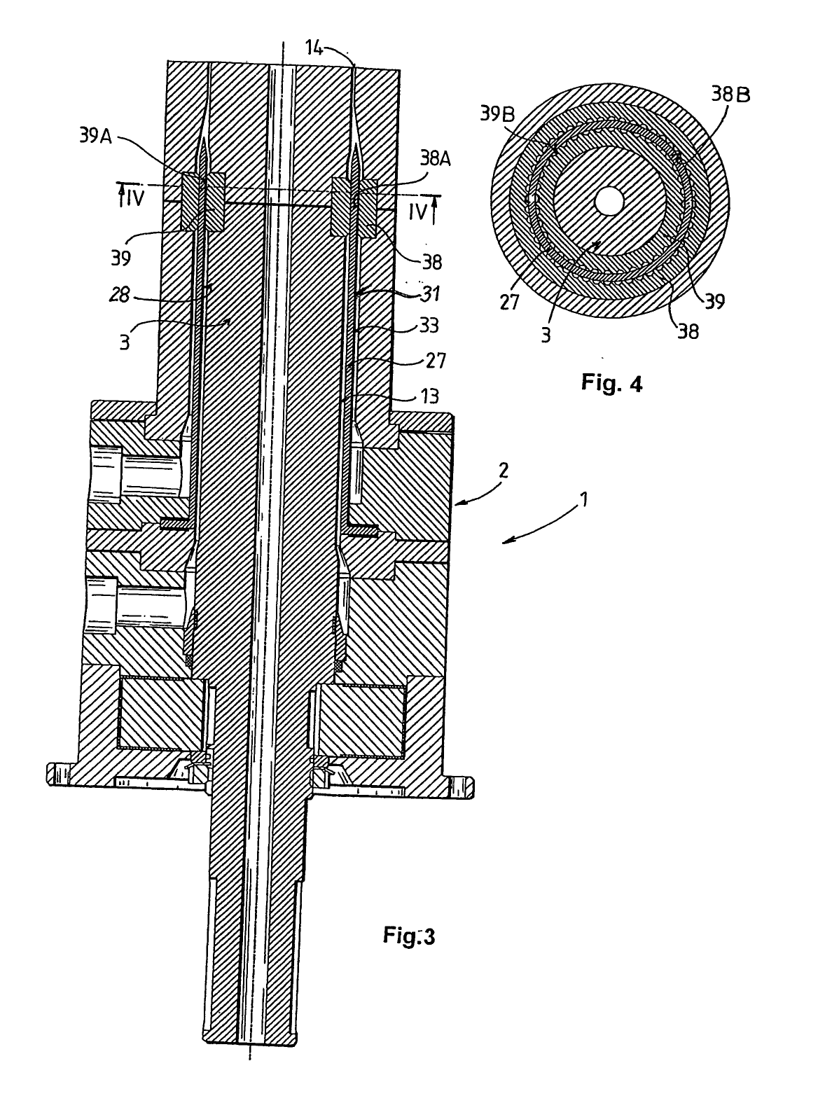

FIGS. 3 and 4 show a preferred embodiment of the extruder nozzle 1 shown in FIG. 2 where the delimiting sleeve 27 being rotatable embedded in the external nozzle component 2 is associated with an external annular insert 38 and/or an internal annular insert 39, which are here replaceable elements. In the present case, the annular inserts 38 and 39 are provided—on their respective external skirt surfaces 38A and 39A—with axially helical, but in cross-section semi-circular grooves 38B and 39B, respectively, adjacent to the delimiting sleeve 27 arranged co-axially with said nozzle core 3 (FIG. 4).

According to a further feature of the present invention at least one special groove 38B and 39B is provided for controlling, even more accurately, the size and shape of the gap, that is, the cross-section of the material flow in the homogenizing ring channel 13 and/or 33. In this embodiment, the gap-controlling grooves 38B and 39B are formed in the surfaces of the annular inserts 38 and 39, respectively, as mentioned above.

This improved gap-control can be previously determined partly by a narrowed fitting gap between the outer and inner skirt surfaces 28 and 31, respectively, of the delimiting sleeve 27 and the adjacent skirt surfaces 38A and 39A of the inserts 38 and 39, respectively, as well as—mainly—by the profile form and size of the controlling grooves 38B and 39B, respectively, always in the function of the material to be processed.

In the embodiment according to FIGS. 3 and 4, the external annular insert 38 controls the cross-section shape of the second homogenizing ring channel 33 for the plastic material of the external foil layer, while the internal annular insert 39 controls the transfer cross-section shape of the first homogenizing ring channel 13 for material of the internal foil layer in the manner above. By this arrangement the viscous torque within the extruder nozzle 1 can also be controlled.

By the arrangement above of the annular inserts 38 and 39, respectively, near the outlet of the extruder nozzle 1, that is, closer to the drawing opening 14, the “self-centralizing” feature of the extruder nozzle core 3 can further be improved.

In other embodiments (not shown), instead of using insert 38 or 39, the at least one gap-controlling groove 38B (39B) can be formed in the external and/or internal surface of the at least one delimiting sleeve 27 and/or in the internal surface of the external nozzle component 2 and/or in the outer surface of the nozzle core 3. Said gap-controlling groove 38B (39B) may have axial and/or helical form and different cross-sections depending on the materials to be processed and the parameters of the technology.

Finally, it is to be noted that based on our disclosure, the procedure and the extruder nozzle in accordance with the present invention can be realized in many other versions and combinations within the claimed scope of protection, but these shall be obvious for a person having ordinary skill in the art. Although thermoplastic basic plastic materials were mentioned in the examples above, the invention can be applied with similar advantages for extruding other materials and products, such as macaroni paste, plastic or metal tubes, etc.

1-9. (canceled)

10. A process for extruding tubular products, particularly blown plastic foil hoses, comprising the steps of feeding a pressurized material, particularly thermoplastic material into an inlet of an extruder nozzle, and forcing this material flow through a duct formed between relatively rotating outer and inner nozzle components, then shaping the tubular product by pressing the material flow through an annular drawing aperture at an outlet end of said duct of the extruder nozzle, characterized in that the material flow entering the extruder nozzle (1) through the inlet (6) in a first radial main direction of progress, and it is distributed along the duct by being first led directly into an annular expansion chamber (7) for distribution and expansion of the material flow, connected directly to the radial inlet (6) and during this step the first radial main direction of progress of the material flow is maintained; the cross-section of said annular expansion chamber (7) is selected at least one order of magnitude greater than that of the radial inlet (6); and when the annular expansion chamber (7) has been completely filled up by the material flow whose pressure has become higher than a flow resistance of an homogenizing ring channel (13) having a cross-section narrowed in a predetermined manner to and connected directly to the annular expansion chamber (7), only then the material flow is moved in a second main direction of progress, which is cross direction, preferably axially to the entering first radial main direction thereof, from the annular expansion chamber (7) into said homogenizing ring channel (13), wherein the material flow is homogenized by the relative rotation of substantially flat surfaces formed at least partly by the external nozzle component (2) being fixed and the internal nozzle core (3) being rotated, and the homogenizing ring channel (13) and/or the annular expansion chamber (7) is/are delimited at least partly by said relatively rotating surfaces, and thereby the material flow is led in the second main direction of progress to said drawing aperture (14) by way of a helical forced movement, wherein the material flow between the radial inlet (6) and the drawing aperture (14) has a single change in its main direction of progress only.

11. A process for extruding tubular products, particularly blown plastic foil hoses, comprising the steps of feeding a pressurized material, particularly thermoplastic material into an inlet of an extruder nozzle, and forcing this material flow through a duct formed between relatively rotating outer and inner nozzle components, then shaping the tubular product by pressing the material flow through an annular drawing aperture at an outlet end of said duct of the extruder nozzle, characterized by maintaining a predetermined temperature of the material flow in the extruder nozzle (1) substantially by internal heat generated in the material itself as a result of kneading work performed by a helical forced motion of the material flow due to relative rotation of substantially flat surfaces formed at least partly by the external nozzle component (2) being fixed and the internal nozzle core (3) being rotated, and a homogenizing ring channel (13) and/or an annular expansion chamber (7) is/are provided with and delimited by said relatively rotating surfaces; and the material flow entering the extruder nozzle (1) through the inlet (6) in a first radial main direction of progress, and it is distributed along the duct by being first led directly into the annular expansion chamber (7) for distribution and expansion of the material flow, connected directly to the radial inlet (6) and during this step the first radial main direction of progress of the material flow is maintained; and when the annular expansion chamber (7) has been completely filled up by the material flow whose pressure has become higher than a flow resistance of the homogenizing ring channel (13) having a cross-section narrowed in a predetermined manner to and connected directly to the annular expansion chamber (7), only then the material flow is moved in a second main direction of progress, which is a cross direction, preferably axially to the entering first radial main direction thereof, from the annular expansion chamber (7) into said homogenizing ring channel (13), and then the material flow is led in the second main direction of progress to said drawing aperture (14) by way of a helical forced movement, wherein the material flow between the radial inlet (6) and the drawing aperture (14) has a single change in its main direction of progress only.

12. An extruder nozzle for producing tubular products, particularly blown plastic foil hoses from pressurized materials, mainly thermoplastic materials, comprising an external nozzle component and an internal nozzle core embedded therein; and a material distribution duct formed between the external nozzle component and the internal nozzle core; the external nozzle component having an inlet for receiving the pressurized material, which is connected to a drawing aperture through the duct, characterized in that the external nozzle component (2) of the extruder nozzle (1) is fixed and the internal nozzle core (3) is rotatable embedded in the fixed external nozzle component (2) and provided with a rotary drive; said material distribution duct comprises an annular expansion chamber (7) connected directly to the inlet (6) which is formed in radial direction in the fixed external nozzle component (2); the cross-section of the annular expansion chamber (7) is at least one order of magnitude greater than that of the radial inlet (6); said material distribution duct comprises a homogenizing annular ring channel (13) connected axially with its one end directly to the annular expansion chamber (7) and its cross-section is narrowed to a predetermined proportion compared to the annular expansion chamber (7), and its other end is connected to the drawing aperture (14).

13. An extruder nozzle for producing tubular products, particularly blown plastic foil hoses from pressurized material, comprising an external nozzle component and an internal nozzle core embedded therein, and a material distribution duct arranged between the external nozzle component and the internal nozzle core; the external nozzle component having an inlet for receiving at least one pressurized material, which is connected to a drawing aperture through said duct, characterized in that the extruder nozzle (1) is suitable for producing multi-layer tubular products, mainly multi-layer foil hoses (T′), wherein the material distribution duct comprises a first annular expansion chamber (7) connected to the first inlet (6) formed in radial direction for receiving a first pressurized material flow; the cross-section of said first annular expansion chamber (7) is greater, preferably at least one order of magnitude greater than that of the first radial inlet (6); the material distribution duct comprises a first homogenizing ring channel (13) connected directly and co-axially to the first annular expansion chamber (7), and a cross-section of the first homogenizing ring channel (13) is narrowed to a predetermined proportion compared to said first annular expansion chamber (7), and is at least partly delimited by a skirt surface (28) of at least one delimiting sleeve (27) embedded freely rotatable in the external nozzle component (2); said at least one delimiting sleeve (27) has another skirt surface (31) delimiting at least partly a second homogenizing ring channel (33), one end of which is connected directly to a second radial inlet (34) receiving a second material flow through a second annular expansion chamber (32), its cross-section is greater, preferably at least one order of magnitude greater than the cross-section of the second homogenizing ring channel (33) or the second radial inlet (34); the other end of the first and second homogenizing ring channels (13, 33) are preferably connected to a common joining chamber (35) which is connected to the drawing aperture (14); wherein the external nozzle component (2), the internal nozzle core (3), and the at least one delimiting sleeve (27) are arranged in a relatively rotatable manner, and the external nozzle part (2) and/or the internal nozzle core (3) and/or said at least one delimiting sleeve (27) can be connected to a rotary drive.

14. An extruder nozzle according to claim 12, characterized in that the annular expansion chamber (7, 32), the homogenizing ring channel (13, 33), the drawing aperture (14) and in a given case the joining chamber (35) are coaxially formed and arranged to a longitudinal axis (4) of the extruder nozzle (1).

15. An extruder nozzle according to claim 12, characterized in that only the lower end of the rotatable nozzle core (3) is embedded in bearings (11, 12) in the fixed external nozzle component (2), allowing a limited radial displacement of an upper end of the nozzle core (3), thereby the upper end of the nozzle core (3) adjacent to the homogenizing ring channel (13; 33) is arranged in a bearing-free manner, so as to be self-centering relative to the external nozzle component (2).

16. An extruder nozzle according to claim 12, characterized in that the rotatable nozzle core (3) is axially divided, one of its parts (3A) provided with an opening delimiting the drawing aperture (14) can be changed for different products.

17. An extruder nozzle according to claim 12, characterized in that the fixed external nozzle component (2) is axially divided into parts (2A, 2B, 2C, 2D), wherein there is an axial distance (24) and at least one connecting ring (25) between the adjacent parts (2B, 2C) for reducing thermal load of the parts (2C, 2D) comprising the bearings (11, 12) of said rotating nozzle core (3).

18. An extruder nozzle according to claim 12, characterized in that it is provided at least one gap-controlling means, preferably insert (38, 39), having at least one groove (38B; 39B) formed as to control in a predetermined manner the size and shape of the material flow cross-section in the homogenizing ring channel (13; 33).

19. An extruder nozzle according to claim 13, characterized in that the annular expansion chamber (7, 32), the homogenizing ring channel (13, 33), the drawing aperture (14) and in a given case the joining chamber (35) are coaxially formed and arranged to a longitudinal axis (4) of the extruder nozzle (1).

20. An extruder nozzle according to claim 13, characterized in that only the lower end of the rotatable nozzle core (3) is embedded in bearings (11, 12) in the fixed external nozzle component (2), allowing a limited radial displacement of an upper end of the nozzle core (3), thereby the upper end of the nozzle core (3) adjacent to the homogenizing ring channel (13; 33) is arranged in a bearing-free manner, so as to be self-centering relative to the external nozzle component (2).

21. An extruder nozzle according to claim 14, characterized in that only the lower end of the rotatable nozzle core (3) is embedded in bearings (11, 12) in the fixed external nozzle component (2), allowing a limited radial displacement of an upper end of the nozzle core (3), thereby the upper end of the nozzle core (3) adjacent to the homogenizing ring channel (13; 33) is arranged in a bearing-free manner, so as to be self-centering relative to the external nozzle component (2).

22. An extruder nozzle according to claim 13, characterized in that the rotatable nozzle core (3) is axially divided, one of its parts (3A) provided with an opening delimiting the drawing aperture (14) can be changed for different products.

23. An extruder nozzle according to claim 14, characterized in that the rotatable nozzle core (3) is axially divided, one of its parts (3A) provided with an opening delimiting the drawing aperture (14) can be changed for different products.

24. An extruder nozzle according to claim 15, characterized in that the rotatable nozzle core (3) is axially divided, one of its parts (3A) provided with an opening delimiting the drawing aperture (14) can be changed for different products.

25. An extruder nozzle according to claim 13, characterized in that the fixed external nozzle component (2) is axially divided into parts (2A, 2B, 2C, 2D), wherein there is an axial distance (24) and at least one connecting ring (25) between the adjacent parts (2B, 2C) for reducing thermal load of the parts (2C, 2D) comprising the bearings (11, 12) of said rotating nozzle core (3).

26. An extruder nozzle according to claim 14, characterized in that the fixed external nozzle component (2) is axially divided into parts (2A, 2B, 2C, 2D), wherein there is an axial distance (24) and at least one connecting ring (25) between the adjacent parts (2B, 2C) for reducing thermal load of the parts (2C, 2D) comprising the bearings (11, 12) of said rotating nozzle core (3).

27. An extruder nozzle according to claim 15, characterized in that the fixed external nozzle component (2) is axially divided into parts (2A, 2B, 2C, 2D), wherein there is an axial distance (24) and at least one connecting ring (25) between the adjacent parts (2B, 2C) for reducing thermal load of the parts (2C, 2D) comprising the bearings (11, 12) of said rotating nozzle core (3).

28. An extruder nozzle according to claim 16, characterized in that the fixed external nozzle component (2) is axially divided into parts (2A, 2B, 2C, 2D), wherein there is an axial distance (24) and at least one connecting ring (25) between the adjacent parts (2B, 2C) for reducing thermal load of the parts (2C, 2D) comprising the bearings (11, 12) of said rotating nozzle core (3).

29. An extruder nozzle according to claim 13, characterized in that it is provided at least one gap-controlling means, preferably insert (38, 39), having at least one groove (38B; 39B) formed as to control in a predetermined manner the size and shape of the material flow cross-section in the homogenizing ring channel (13; 33).
